(19) United States
(12) Patent Application Publication
(10) Pub. No.: US 2006/0043902 A1
(43) Pub. Date: Mar. 2, 2006

(54) Power supply device with built-in cord spool for a power transmission cord

(76) Inventors: Sung-Lin Tsai, Kuei-Shan Hsiang (TW); Jung-Chung Chen, Pei-Te City (TW); Yum-Ming Yu, Hsi-Chih City (TW); Chun-Ming Wu, Tu-Cheng City (TW); Yi-Cheng Chang, Taipei City (TW)

Correspondence Address: TROP PRUNER & HU, PC, 8554 KATY FREEWAY, SUITE 100, HOUSTON, TX, 77024, US

(21) Appl. No.: 10/927,721

(22) Filed: Aug. 27, 2004

(51) Int. Cl. H05B 37/00

(52) U.S. Cl. 315/86

(57) ABSTRACT

A power supply device for an electronic apparatus includes a housing, a battery unit disposed in the housing, a control circuit disposed in the housing and coupled electrically to the battery unit, and a power transmission cord having an inner end coupled to the control circuit, and an outer end that extends out of the housing and that is terminated by an electrical connector to permit electrical connection with the electronic apparatus. The control circuit is operable so as to control supply of battery power from the battery unit to the electronic apparatus via the power transmission cord. A cord spool is mounted operably in the housing, and is operable for winding and unwinding the power transmission cord thereon.

### BACKGROUND OF THE INVENTION

1. Field of the Invention

The present invention relates to a power supply device, more particularly to a power supply device with a built-in cord spool for a power transmission cord.

2. Description of the Related Art

Power supply devices are being increasingly used with portable electronic apparatuses, such as laptop computers and digital cameras. The power supply device may be connected to the electronic apparatus when the internal rechargeable batteries of the latter have lost their charge, and when there is no nearby available power outlet. Such a power supply device has proved particularly useful in consideration of the limited run time provided by the internal batteries of electronic apparatuses.

However, a drawback of the power supply device is that it adversely affects the overall portability and ease-of-use of the electronic apparatus as a result of the user having to carry, set up, and pack the power supply device itself, as well as the additional power cords associated with the power supply device. There is a need, therefore, for a power supply device that is structured such that it is less cumbersome to transport and to attach to the electronic apparatus.

### SUMMARY OF THE INVENTION

Therefore, the object of the present invention is to provide a power supply device having a built-in cord spool that enables the internal reception and easy extension of a power transmission cord, thereby enhancing the portability of the power supply device and allowing simpler connection to an electronic apparatus.

According to the present invention, a power supply device for an electronic apparatus includes a housing, a battery unit disposed in the housing, a control circuit disposed in the housing and coupled electrically to the battery unit, and a power transmission cord having an inner end coupled to the control circuit, and an outer end that extends out of the housing and that is terminated by an electrical connector to permit electrical connection with the electronic apparatus. The control circuit is operable so as to control the supply of battery power from the battery unit to the electronic apparatus via the power transmission cord. A cord spool is mounted operably in the housing, and is operable for winding and unwinding the power transmission cord thereon.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of a power supply device with a built-in cord spool for a power transmission cord according to a preferred embodiment of the present invention;

FIG. 2 is a schematic view to illustrate a control circuit, a battery unit, and the cord spool of the preferred embodiment, as well as to illustrate extension of the power transmission cord for connection to an electronic apparatus; and

FIG. 3 is a schematic circuit block diagram of the control circuit of the preferred embodiment.

### DETAILED DESCRIPTION OF THE PREFERRED EMBODIMENTS

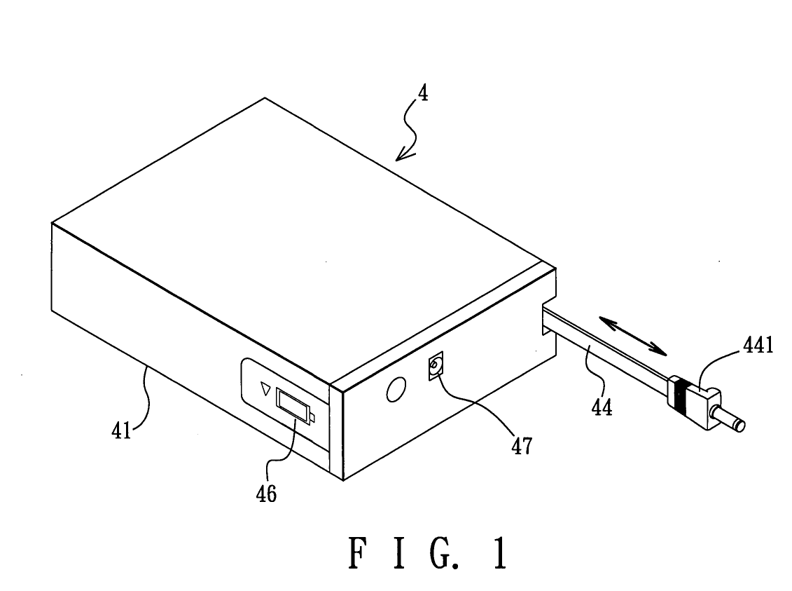

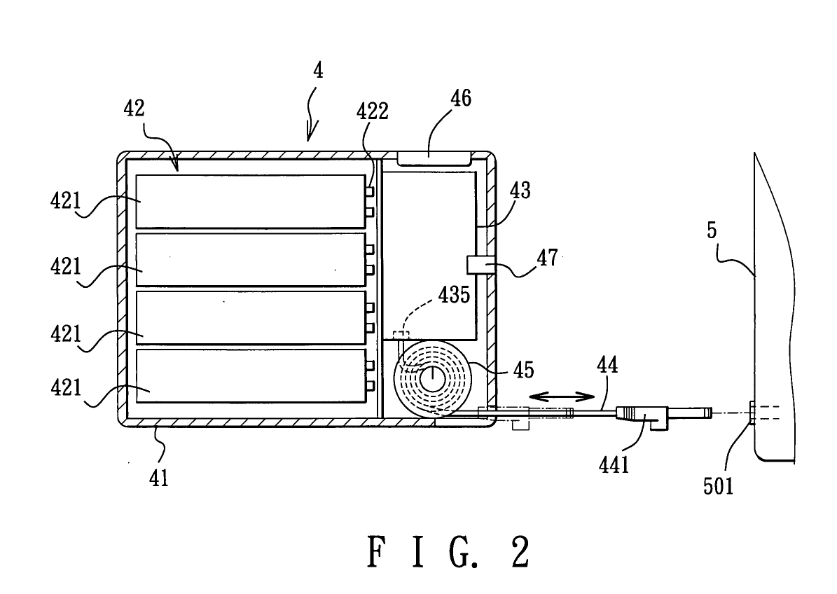

Referring to FIGS. 1 and 2, a power supply device 4 according to a preferred embodiment of the present invention is used to provide power to an electronic apparatus 5, such as a laptop computer or a digital camera. The power supply device 4 includes a housing 41, a battery unit 42, a control circuit 43, a power transmission cord 44, a cord spool 45, a display unit 46, and a power input unit 47.

The battery unit 42 is mounted in the housing 41, and includes a plurality of rechargeable battery cells 421. Each of the battery cells 421 includes a pair of terminals 422, and each of the terminals 422 is electrically coupled to the control circuit 43 to thereby enable charging and discharging of the battery cells 421 under the control of the control circuit 43. Power is received for charging the battery cells 421 through the power input unit 47, which is mounted on the housing 41, electrically coupled to the control circuit 43, and adapted to receive a charging signal for charging the battery cells 421. The battery cells 421 may be lithium-ion (Li-ion) battery cells, nickel-metal hydride (Ni-MH) battery cells, lithium-polymer (Li-polymer) battery cells, nickel cadmium (Ni—Cd) battery cells, fuel cells, nickel-hydrogen (Ni—H) battery cells, etc.

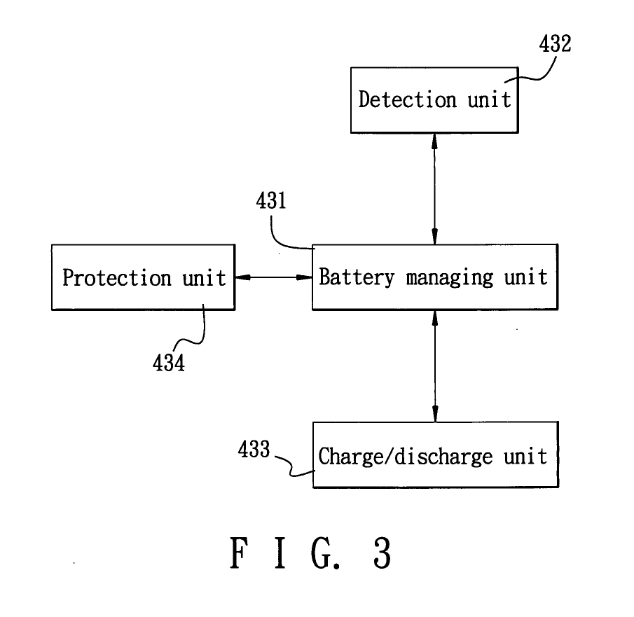

The control circuit 43 controls the charging and discharging of the battery unit 42. In the case of discharging of the battery unit 42, this is accomplished through a power output port 435 of the control circuit 43 to which the power transmission cord 45 is electrically coupled. With reference to FIG. 3, the control circuit 43 includes a battery managing unit 431, a detection unit 432, a charge/discharge unit 433, and a protection unit 434.

The battery managing unit 431 of the control circuit 43 performs overall control of the power supply device 4 to effect charging and discharging of the battery unit 42, as well as display on the display unit 46. To perform these functions, the battery managing unit 431 is electrically coupled to the detection unit 432, the charge/discharge unit 433, the protection unit 434, and the display unit 46.

The detection unit 432 of the control circuit 43 detects battery status variables, such as voltage, remaining capacity, and temperature, and generates corresponding battery status signals. The battery status signals are transmitted to the battery managing unit 431, which processes the battery status signals to enable display on the display unit 46 in a predetermined, user-friendly format. The battery status signals may be selectively processed for display on the display unit 46. For example, only battery status signals corresponding to detected voltage may be processed for display on the display unit 46. The display unit 46 may be a liquid crystal display (LCD) or a light emitting diode (LED) display.

The charge/discharge unit 433 of the control circuit 43 maintains voltage and current levels during charging and discharging of the battery unit 42 to within acceptable levels. As described above, charging is realized through the power input unit 47, while discharging occurs through the power output port 435. Charging of the battery unit 42 is performed in conjunction with the battery managing unit 431. That is, when an external power source is connected to the power input unit 47, the battery managing unit 431 determines from the battery status signals whether the battery unit 42 requires charging. If it is determined that the battery unit 42 requires charging, the battery managing unit 431 performs control to activate the charge/discharge unit 433, which operates to control voltage and current to predetermined levels. The battery managing unit 431 determines the point at which the battery unit 42 becomes fully charged, then performs control such that the charge/discharge unit 433 is deactivated so that power is no longer supplied to the battery unit 42. In the case where the external power source is an AC voltage source, the charge/discharge unit 433 is able to perform the operations necessary to obtain a suitable DC voltage (e.g., power transformation, rectification, filtering, and regulation).

The protection unit 434 of the control circuit 43 operates to protect the battery unit 42 by performing a cut-off operation when a temperature of the battery unit 42 exceeds a predetermined level, or when overvoltage and/or overcurrent problems occur in the battery unit 42.

The power transmission cord 44 is used to transmit the power signal processed by the charge/discharge unit 433 of the control circuit 43 to the electronic apparatus 5. The power transmission cord 44 includes an inner end coupled to the power output port 435 of the control circuit 43, and an outer end that extends out of the housing 41 and that is terminated by an electrical connector 441 to permit electrical connection with an input port 501 of the electronic apparatus 5.

The cord spool 45 is mounted in the housing 41, and is operable for winding and unwinding the power transmission cord 44 thereon in a conventional manner. An example of a conventional configuration that may be employed is found in U.S. Pat. No. 6,461,191 entitled, “Wire Receiving Device Without Connection Point.” With the use of such a structure, the power transmission cord 44 may be easily wound by action of a winding spring, the operation of which is initiated by the user, and unwound by the user pulling on the electrical connector 441 or the power transmission cord 44 itself in a direction away from the housing 41.

In view of the foregoing construction, the portability of the power supply device 4 is enhanced, and set up and packing away of the power supply device 4 are made simpler and more convenient.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

We claim:

1. A power supply device for an electronic apparatus, comprising:
a housing;
a battery unit disposed in said housing;
a control circuit disposed in said housing and coupled electrically to said battery unit;
a power transmission cord having an inner end coupled to said control circuit, and an outer end that extends out of said housing and that is terminated by an electrical connector to permit electrical connection with the electronic apparatus;
said control circuit being operable so as to control supply of battery power from said battery unit to the electronic apparatus via said power transmission cord; and
a cord spool mounted operably in said housing and operable for winding and unwinding said power transmission cord thereon.

2. The power supply device as claimed in claim 1, wherein:
said battery unit includes at least one rechargeable battery cell;
said power supply device further comprising a power input unit mounted on said housing, coupled electrically to said control circuit, and adapted to receive a charging signal;
said control circuit being further operable so as to control charging of said battery unit using the charging signal.

3. The power supply device as claimed in claim 2, further comprising a display unit mounted on said housing, coupled electrically to said control circuit, and controlled by said control circuit to display battery status information thereon.

4. The power supply device as claimed in claim 3, wherein said display unit is one of a liquid crystal display and a light emitting diode display.

5. The power supply device as claimed in claim 2, wherein the charging signal is one of an alternating current signal and a direct current signal.
